(19) United States
(12) Patent Application Publication
(10) Pub. No.: US 2025/0287404 A1
(43) Pub. Date: Sep. 11, 2025

(54) METHODS AND APPARATUSES FOR S-SSB TRANSMISSION IN UNLICENSED SPECTRUM

(71) Applicant: Lenovo (Beijing) Limited, Beijing (CN)

(72) Inventors: Xin Guo, Beijing (CN); Haipeng Lei, Beijing (CN); Xiaodong Yu, Beijing (CN); Zhennian Sun, Beijing (CN)

(73) Assignee: Lenovo (Beijing) Limited, Beijing (CN)

(21) Appl. No.: 18/862,825

(22) PCT Filed: May 6, 2022
(86) PCT No.: PCT/CN2022/091304

§ 371 Date: Nov. 4, 2024

(51) Int. Cl. H04W 72/25; H04L 5/00; H04W 72/0446; H04W 72/0453; H04W 74/0808

(52) U.S. Cl. CPC H04W 72/25; H04L 5/0098; H04W 72/0446; H04W 72/0453; H04W 74/0808

(57) ABSTRACT

The present disclosure relates to methods and apparatuses for sidelink synchronization signal block (S-SSB) transmission in an unlicensed spectrum. One embodiment of the present disclosure provides a user equipment (UE), which includes: a processor configured to cause the UE to: receive configuration information for S-SSB in an unlicensed spectrum including at least one of the following: a first configuration associated with an S-SSB structure including at least one of: a first structure configuration in the time domain, a second structure configuration in the frequency domain, or a configuration for physical sidelink broadcast channel (PSBCH); or a second configuration associated with an S-SSB period including one or more S-SSB occasions; select at least one S-SSB occasion based on the configuration information; and transmit an S-SSB on the at least one S-SSB occasion in response to a listen before talk (LBT) procedure associated with the at least one S-SSB occasion being successful.

### TECHNICAL FIELD

The present disclosure relates to wireless communication technology, and more particularly, to methods and apparatuses for sidelink (SL) synchronization signal block (SSB) transmission in an unlicensed spectrum.

### BACKGROUND OF THE INVENTION

A sidelink is a long-term evolution (LTE) feature introduced in 3^{rd} generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

Sidelink synchronization information is carried in an SL SSB (S-SSB). In an unlicensed spectrum, the S-SSB transmission needs to meet requirements such as the occupied channel bandwidth (OCB) requirement, the listen-before-talk (LBT) requirement, etc. Therefore, new designs for S-SSB transmission in an unlicensed spectrum are needed.

### SUMMARY

One embodiment of the present disclosure provides a UE, which includes: a transceiver; and a processor coupled with the transceiver and configured to: receive, with the transceiver, configuration information for S-SSB in an unlicensed spectrum including at least one of the following: a first configuration associated with an S-SSB structure including at least one of: a first structure configuration in the time domain, a second structure configuration in the frequency domain, or a configuration for physical sidelink broadcast channel (PSBCH); or a second configuration associated with an S-SSB period including one or more S-SSB occasions, select at least one S-SSB occasion based on the configuration information; and transmit, with the transceiver, an S-SSB on the at least one S-SSB occasion in response to a listen before talk (LBT) procedure associated with the at least one S-SSB occasion being successful.

In some embodiments, the configuration information is based on at least one of the following granularities: per channel bandwidth, per carrier, per bandwidth part, per frequency range, or per subcarrier spacing (SCS).

In some embodiments, the configuration information is received via at least one of: a master information block (MIB) message, a system information block (SIB) message, a radio resource control (RRC) signalling, or a medium access control (MAC) control element (CE).

In some embodiments, the first structure configuration in the time domain includes at least one of: a number of symbol(s) as a gap for performing an LBT procedure in an S-SSB slot, or location(s) of the symbol(s) in the S-SSB slot.

In some embodiments, the second structure configuration in the frequency domain includes at least one of the following: a number of S-SSB repetition(s) in a frequency band; location(s) of the S-SSB repetition(s) in the frequency band; a number of resource block(s) (RB(s)) unoccupied by the S-SSB repetition(s) in the frequency band; or location(s) of the RB(s) in the frequency band.

In some embodiments, the second structure configuration in the frequency domain includes at least one of the following: an interlace pattern in a frequency band; index(es) of available interlace(s) in the frequency band; a number of interlace(s) for one S-SSB; or an indicator indicating whether frequency domain multiplexing (FDM) is enabled.

In some embodiments, the processor is further configured to: select interlace(s) for transmitting the S-SSB from the available interlace(s) based at least in part on the second structure configuration in the frequency domain; and map the S-SSB to be transmitted to RB sets of the selected interlace(s).

In some embodiments, in the case that the indicator indicating that FDM is not enabled, the processor is further configured to: select the interlace(s) for transmitting the S-SSB based on random selection: or select first one or more interlaces from the available interlace(s) for transmitting the S-SSB.

In some embodiments, in the case that the indicator indicating that FDM is enabled, the processor is further configured to: select the interlace(s) for transmitting the S-SSB based on at least one of: random selection, an identifier of the UE, an identifier of a sidelink synchronization signal (SLSS) associated with the UE, or a priority level of synchronization reference of the UE.

In some embodiments, the configuration for PSBCH indicates that a PSBCH includes at least one of the following: a first indicator indicating whether an S-SSB including the PSBCH is within a channel occupancy time (COT); a second indicator indicating whether a next S-SSB is within a current COT; a parameter associated with quasi-colocation (QCL) relation; or a third indicator indicating whether a beam is used for transmission of S-SSB repeatedly within an S-SSB window or not.

In some embodiments, the second configuration includes at least one of the following: a length of the S-SSB period: a number of S-SSB window(s) within the S-SSB period; a number of S-SSB occasion(s) within each S-SSB window; an offset from a starting slot of the S-SSB period to a starting slot of a first S-SSB window of the S-SSB window(s) within the S-SSB period; an interval between starting slots of two adjacent S-SSB windows; an indicator indicating whether each S-SSB window is a type 1 window, a type 2 window, or a type 3 window; or an LBT procedure type.

In some embodiments, the number of the S-SSB occasion(s) within each S-SSB window is determined based on at least one of the following: a channel access procedure associated with an S-SSB; a configuration of beam-based sidelink transmission; or a frequency band associated with the S-SSB.

Another embodiment of the present disclosure provides a BS, which includes: a transceiver; and a processor coupled with the transceiver and configured to: transmit, with the transceiver, configuration information for S-SSB in an unlicensed spectrum including at least one of the following: a first configuration associated with an S-SSB structure including at least one of: a first structure configuration in the time domain, a second structure configuration in the frequency domain, or a configuration for PSBCH; or a second configuration associated with an S-SSB period including one or more S-SSB occasions.

In some embodiments, the configuration information is based on at least one of the following granularities: per channel bandwidth, per carrier, per bandwidth part, per frequency range, or per SCS.

In some embodiments, the configuration information is transmitted via at least one of: a MIB message, a SIB message, an RRC signalling, or a MAC CE.

In some embodiments, the first structure configuration in the time domain includes at least one of: a number of symbol(s) as a gap for performing an LBT procedure in an S-SSB slot, or location(s) of the symbol(s) in the S-SSB slot.

In some embodiments, the second structure configuration in the frequency domain includes at least one of the following: a number of S-SSB repetition(s) in a frequency band; location(s) of the S-SSB repetition(s) in the frequency band; a number of RBs unoccupied by the S-SSB repetition(s) in the frequency band; or location(s) of the RB(s) in the frequency band.

In some embodiments, the second structure configuration in the frequency domain includes at least one of the following: an interlace pattern in a frequency band; index(es) of available interlace(s) in the frequency band; a number of interlace(s) for one S-SSB; or an indicator indicating whether FDM is enabled.

In some embodiments, the configuration for PSBCH indicates that a PSBCH includes at least one of the following: a first indicator indicating whether an S-SSB including the PSBCH is within a COT; a second indicator indicating whether a next S-SSB is within a current COT; a parameter associated with QCL relation; or a third indicator indicating whether a beam is used for transmission of S-SSB repeatedly within an S-SSB window or not.

In some embodiments, the second configuration includes at least one of the following: a length of the S-SSB period, a number of S-SSB window(s) within the S-SSB period; a number of S-SSB occasion(s) within each S-SSB window; an offset from a starting slot of the S-SSB period to a starting slot of a first S-SSB window of the S-SSB window(s) within the S-SSB period; an interval between starting slots of two adjacent S-SSB windows; an indicator indicating whether each S-SSB window is a type 1 window, a type 2 window, or a type 3 window; or an LBT procedure type.

In some embodiments, the number of the S-SSB occasion(s) within each S-SSB window is determined based on at least one of the following: a channel access procedure associated with an S-SSB; a configuration of beam-based sidelink transmission; or a frequency band associated with the S-SSB.

Yet another embodiment of the present disclosure provides a method performed by a UE, which includes: receiving configuration information for S-SSB in an unlicensed spectrum including at least one of the following: a first configuration associated with an S-SSB structure including at least one of: a first structure configuration in the time domain, a second structure configuration in the frequency domain, or a configuration for PSBCH; or a second configuration associated with an S-SSB period including one or more S-SSB occasions; selecting at least one S-SSB occasion based on the configuration information; and transmitting an S-SSB on the at least one S-SSB occasion in response to an LBT procedure associated with the at least one S-SSB occasion being successful.

Still another embodiment of the present disclosure provides a method performed by a BS, which includes: transmitting configuration information for S-SSB in an unlicensed spectrum including at least one of the following: a first configuration associated with an S-SSB structure including at least one of: a first structure configuration in the time domain, a second structure configuration in the frequency domain, or a configuration for PSBCH; or a second configuration associated with an S-SSB period including one or more S-SSB occasions.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary wireless communication system according to some embodiments of the present disclosure.

FIG. 2 illustrates an exemplary S-SSB slot according to some embodiments of the present disclosure.

FIG. 3 illustrates an exemplary distribution of occasions for S-SSB according to some embodiments of the present disclosure.

FIG. 4 illustrates an exemplary S-SSB structure in the time domain according to some embodiments of the present disclosure.

FIG. 5A illustrates an exemplary repetition structure for S-SSB in the frequency domain according to some embodiments of the present disclosure.

FIG. 5B illustrates another exemplary repetition structure for S-SSB in the frequency domain according to some embodiments of the present disclosure.

FIG. 6 illustrates an exemplary interlaced structure for S-SSB in the frequency domain according to some embodiments of the present disclosure.

FIG. 7 illustrates an exemplary distribution of S-SSB occasions within one S-SSB period according to some embodiments of the present disclosure.

FIG. 8 illustrates another exemplary distribution of S-SSB occasions within one S-SSB period according to some embodiments of the present disclosure.

FIG. 9 illustrates a flowchart of an exemplary method for S-SSB transmission in an unlicensed spectrum according to some embodiments of the present disclosure.

FIG. 10 illustrates a simplified block diagram of an exemplary apparatus for S-SSB transmission in an unlicensed spectrum according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3GPP 5G new radio (NR), 3GPP LTE, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

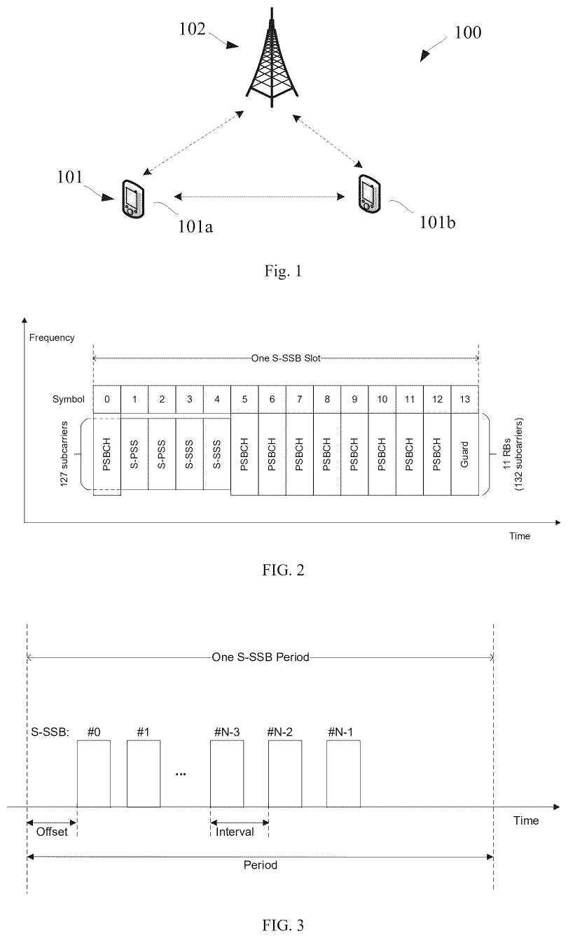

FIG. 1 illustrates an exemplary wireless communication system 100 in accordance with some embodiments of the present disclosure.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

In some embodiments of the present disclosure, UE 101a may communicate with UE 101b over licensed spectrums, whereas in other embodiments, UE 101a may communicate with UE 101b over unlicensed spectrums.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present disclosure, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS(s) 102 may communicate using other communication protocols, such as the IEEE 802.11 family of wireless communication protocols. Further, in some embodiments of the present disclosure, BS(s) 102 may communicate over licensed spectrums, whereas in other embodiments, BS(s) 102 may communicate over unlicensed spectrums. The present disclosure is not intended to be limited to the implementation of any particular wireless communication system architecture or protocol. In yet some embodiments of the present disclosure, BS(s) 102 may communicate with UE(s) 101 using the 3GPP 5G protocols.

Sidelink synchronization information is carried in an S-SSB that consists of PSBCH, sidelink primary synchronization signal (S-PSS) and sidelink secondary synchronization signal (S-SSS). FIG. 2 illustrates an exemplary S-SSB slot according to some embodiments of the present disclosure. In the embodiments of FIG. 2, a normal cyclic prefix (CP) is used.

Referring to FIG. 2, an S-SSB occupies one slot in the time domain and occupies 11 RBs in the frequency domain. Each RB spans 12 subcarriers, thus the S-SSB bandwidth is 132 (11×12) subcarriers. In the example of FIG. 2, the S-SSB slot may include 14 OFDM symbols in total, e.g., symbol #0 to symbol #13. The S-PSS is transmitted repeatedly on the second and third symbols in the S-SSB slot, e.g., symbol #1 and symbol #2. The S-SSS is transmitted repeatedly on the fourth and fifth symbols in the S-SSB slot, e.g., symbol #3 and symbol #4. The S-PSS and the S-SSS occupy 127 subcarriers in the frequency domain, which are from the third subcarrier relative to the start of the S-SSB bandwidth up to the 129th subcarrier.

The S-PSS and the S-SSS are jointly referred to as the sidelink synchronization signal (SLSS). The SLSS is used for time and frequency synchronization. By detecting the SLSS sent by a synchronization reference UE (also referred to as a SyncRef UE), a UE is able to synchronize to the SyncRef UE and estimate the beginning of the frame and carrier frequency offsets.

The S-PSS may be generated from the maximum length sequences (m-sequences) that use the same design (i.e., generator polynomials, initial values and cyclic shifts, etc.) which is used for generating the in-sequences in the primary synchronization signal (PSS) in the 3GPP documents. In NR Uu, there are three candidate sequences for PSS. However, only two candidate sequences are used for S-PSS.

The S-SSS may be generated from the Gold sequences that use the same design (i.e., generator polynomials, initial values and cyclic shifts, etc.) which is utilized for generating the Gold sequences for the secondary synchronization signal (SSS) in the 3GPP documents. This results in 336 candidate sequences for S-SSS like for the SSS in NR Uu.

For the transmission of SLSS within an S-SSB, a SyncRef UE may select an S-PSS and an S-SSS out of the candidate sequences based on an SLSS identifier (ID). The SLSS ID represents an identifier of the SyncRef UE and conveys a priority of the SyncRef UE as in LTE V2X. Each SLSS ID corresponds to a unique combination of an S-PSS and an S-SSS out of the 2 S-PSS candidate sequences and the 336 S-SSS candidate sequences.

The main purpose of the PSBCH is to provide system-wide information and synchronization information that is required by a UE for establishing a sidelink connection. In the example of FIG. 2, the PSBCH is transmitted on the first symbol (e.g., symbol #0) and the eight symbols (e.g., symbol #5 to symbol #12) after the S-SSS in the S-SSB slot. In the case that an extended CP is used, the PSBCH is transmitted on the first symbol and the six symbols after the S-SSS in the S-SSB slot. The PSBCH occupies 132 subcarriers in the frequency domain. The PSBCH in the first symbol of the S-SSB slot is used for automatic gain control (AGC). The last symbol, e.g., symbol #13, in the S-SSB slot is used as a guard symbol.

A UE may be configured with a configuration for an S-SSB period including one or more S-SSB occasions. FIG. 3 illustrates an exemplary distribution of occasions for S-SSB according to some embodiments of the present disclosure.

As shown in FIG. 3, within one S-SSB period, N S-SSB occasions are included, which are S-SSB #0, S-SSB #1, . . . , S-SSB #N−3, S-SSB #N−2, and S-SSB #N−1 respectively. A length of the S-SSB period is marked as “Period”. There is an offset from the starting slot of the S-SSB period to the first S-SSB occasion within the S-SSB period, e.g., S-SSB #0, which is marked as “Offset” in FIG. 3. There is an interval between two adjacent S-SSB occasions (e.g., between starting slots of the two adjacent S-SSB occasions). For example, as shown in FIG. 3, the interval between S-SSB #N−3 and S-SSB #N−2 is marked as “Interval”. Accordingly, the configuration for one S-SSB period may include at least one of the parameter “Period”, the parameter “Offset”, or the parameter “Interval”. A UE may select one or more SSB occasions for transmitting SSB(s) based on the configuration.

The S-SSB period may include 16 frames, e.g., 160 ms, as specified in NR V2X. Possible numbers of S-SSB occasions within one S-SSB period are shown in the following Table 1:

TABLE 1
Number of S-SSB occasions within an S-SSB Period (160 ms)

| Frequency | Subcarrier spacing | Number of S-SSB occasions per |
|---|---|---|
| range | (SCS) | period |
| FR1 | 15 kHz | 1 |
| | 30 kHz | 1, 2 |
| | 60 kHz | 1, 2, 4 |
| FR2 | 60 kHz | 1, 2, 4, 8, 16, 32 |
| | 120 kHz | 1, 2, 4, 8, 16, 32, 64 |

For S-SSB transmission in an unlicensed spectrum, several issues need to be solved. The first issue is how to meet the OCB requirement for large channel bandwidth in the unlicensed spectrum. According to the OCB requirement, the bandwidth containing 99% of the power of the signal, shall be between 80% and 100% of declared nominal channel bandwidth. The second issue is how to meet the LBT requirement. A UE needs to perform an LBT procedure before the S-SSB transmission.

The present disclosure provides various solutions for S-SSB transmission in the unlicensed spectrum which can solve at least one of the above issues.

### Solution 1

In the unlicensed spectrum, before performing any transmission, the apparatus (such as a UE) needs to perform an LBT procedure. The present disclosure proposes to introduce a gap for channel access procedure with LBT into the S-SSB slot structure. The gap may include a number of symbols, where the number, which may be referred to as N_{symbol}^{gap}, may depend on the SCS.

For a shorter SCS (e.g., 15 kHz or 30 kHz), the number of symbols of the gap may include one symbol. In some embodiments, the guard symbol as shown in FIG. 2, which includes one symbol, may be used as the gap for channel access procedure. In some other embodiments, any symbol in the 14 symbols in the S-SSB slot may be used as the gap for channel access procedure.

For a longer SCS (e.g., 60 kHz or 120 kHz), the number of symbols of the gap may include more than one symbol. In some embodiments, the guard symbol as shown in FIG. 2, which includes one symbol, as well as one or more symbols prior to the guard symbol, such as, symbol #12, symbol #11, etc., may be used as the gap for channel access procedure. In some other embodiments, other symbols in the 14 symbols in the S-SSB slot may be used as the gap for channel access procedure. For example, it is supposed that 3 symbols are needed for performing the channel access procedure with LBT, and symbol #11, symbol #12, and symbol #13 may be used for performing an LBT procedure. Alternatively, other symbols, such as symbol #6, symbol #7, and symbol #8, or symbol #0, symbol #1, and symbol #2, may be used for performing the LBT procedure.

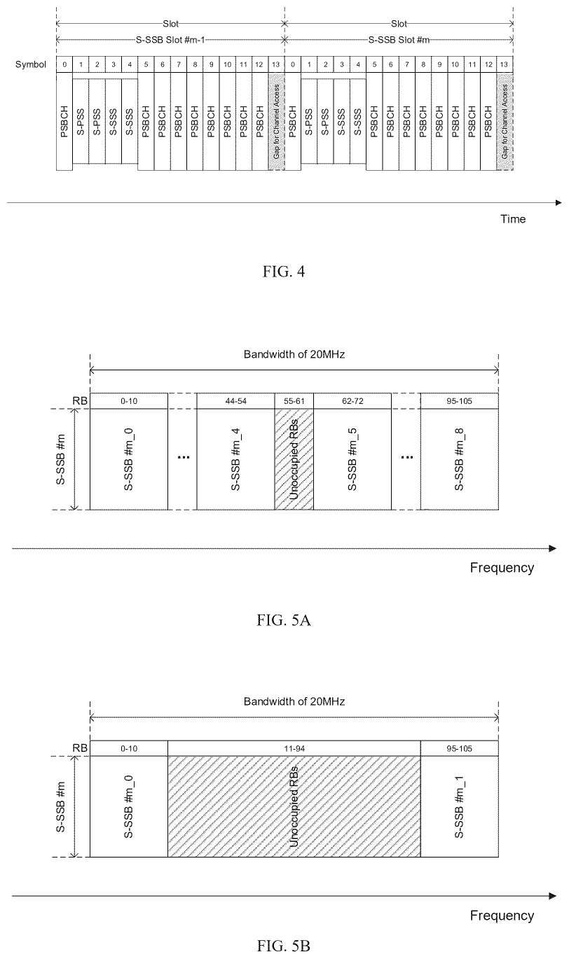

FIG. 4 illustrates an exemplary S-SSB structure in the time domain according to some embodiments of the present disclosure.

Two S-SSB slots, e.g., slot #m−1 and slot #m, are illustrated in FIG. 4. Each S-SSB slot includes 14 OFDM symbols and has the same structure as that illustrated in FIG. 2 except that the last symbol, e.g., symbol #13, in each S-SSB slot is a gap for channel access procedure. More specifically, the gap is used by a UE to perform the channel access procedure with LBT For example, in the case that an LBT procedure performed in symbol #13 of slot #m−1 is successful, a COT including slot #m may be initiated and the UE may transmit an S-SSB in slot #m.

A BS or a network may transmit configuration information of the gap to the UE, where the configuration information of the gap may include a structure configuration in the time domain, e.g., the S-SSB slot format. The S-SSB slot format may include the number of the symbol(s) as the gap for channel access procedure (i.e., the gap for performing an LBT procedure), or the location(s) of the symbol(s) as the gap for channel access procedure. For the example in FIG. 4, the configuration information of the gap may indicate that the number of the symbol(s) as the gap for channel access procedure is one, and the location of the symbol as the gap for channel access procedure is symbol #13; or the configuration information of the gap may merely indicate the location of the symbol as the gap for channel access procedure is symbol #13, which implies that the number of the symbol(s) as the gap for channel access procedure is one.

The granularity of the configuration information of the gap may be:
1. per channel bandwidth; the configuration information may be different for different channel bandwidths;
2. per carrier, the configuration information may be different for different carriers;
3. per bandwidth part; the configuration information may be different for different bandwidth parts;
4. per frequency range; the configuration information may be different for different frequency ranges, such as frequency range 1 (FR1), FR2, etc., or
5. per SCS: the configuration information may be different for different SCSs, such as 15 kHz, 30 kHz, etc.

The configuration information of the gap may be transmitted from the BS to the UE via a MIB message, a SIB message, an RRC signalling, a MAC CE, or the like.

### Solution 2

In order to meet the OCT requirement, the present disclosure proposes to transmit S-SSB repetitions across the required channel bandwidth.

For example, it is assumed that a frequency band (e.g., a channel) includes a number of RBs in the frequency domain, which may be represented as N_{RB}^{CH}, and each S-SSB repetition includes N_{RB}^{S-SSB} RBs in the frequency domain.

Nᵣₑₚₑₜᵢₜᵢₒₙ^{S-SSB} S-SSB repetitions may be transmitted in the frequency band. The maximum value of Nᵣₑₚₑₜᵢₜᵢₒₙ^{S-SSB} may be calculated by the following equation (1):

$${N}_{repetition , max}^{S - SSB} = ⌊ \frac{{N}_{RB}^{CH}}{{N}_{RB}^{S - SSB}} ⌋ \qquad ( 1 )$$

There may be some unoccupied RBs in the frequency band. The number of unoccupied RBs, which may be represented as N_{RB}^{unoccupied}, may be calculated by the following equation (2):

$${N}_{RB}^{unoccupied} = {N}_{RB}^{CH} - {N}_{RB}^{S - SSB} \times {N}_{repetition}^{S - SSB} \qquad ( 2 )$$

The location(s) of the unoccupied RB(s) may be deployed based on the OCB requirements. For example, the unoccupied RB(s) may be deployed at any of the following locations: close to the centre frequency of the frequency band, at the edge of the frequency band, at the start of the frequency band, at the end of the frequency band, between any two S-SSB repetitions, or other locations.

In the case that N_{RB}^{CH} is divisible by N_{RB}^{S-SSB}, there may be Nᵣₑₚₑₜᵢₜᵢₒₙ^{S-SSB} S-SSB repetitions without unoccupied RBs in the frequency band.

Nᵣₑₚₑₜᵢₜᵢₒₙ^{S-SSB} may be any number no greater than N_{repetition,max}^{S-SSB} as long as the Nᵣₑₚₑₜᵢₜᵢₒₙ^{S-SSB} S-SSB repetitions can satisfy the OCB requirement. For example, there may be only two S-SSB repetitions, and the offset in frequency between the first RB (lowest in the frequency domain) of the first S-SSB repetition and the last RB (highest in the frequency domain) of the second S-SSB repetition is between 800% and 100% of nominal channel bandwidth of the channel.

FIG. 5A illustrates an exemplary repetition structure for S-SSB in the frequency domain according to some embodiments of the present disclosure.

Referring to FIG. 5A, the bandwidth of a frequency band is 20 MHz, the SCS thereof is 15 kHz, and the number of RBs in the frequency band equals 106, i.e., N_{RB}^{CH}=106. An S-SSB slot indexed with #m, i.e., S-SSB #m, is repeatedly mapped within the frequency band. According to equation (1), the maximum number of S-SSB repetitions is calculated as follows:

$${N}_{repetition , max}^{S - SSB} = ⌊ \frac{{N}_{RB}^{CH}}{{N}_{RB}^{S - SSB}} ⌋ = ⌊ \frac{106}{11} ⌋ = 9$$

In the example of FIG. 5A, Nᵣₑₚₑₜᵢₜᵢₒₙ^{S-SSB}=9. The number of unoccupied RBs is calculated according to equation (2) as follows:

$${N}_{RB}^{unoccupied} = {N}_{RB}^{CH} - {N}_{RB}^{S - SSB} \times {N}_{repetition}^{S - SSB} = 106 - 11 \times 9 = 7$$

Furthermore, the unoccupied RB(s) are configured to be deployed in the centre frequency of the frequency band.

According to the above, nine S-SSB repetitions of S-SSB #m (e.g., SSB #m_0 to SSB #m_8) are transmitted in the frequency band, where each S-SSB repetition includes 11 consecutive RBs, and seven unoccupied RBs are deployed in the centre frequency of the frequency band, for example, between the fifth S-SSB repetition (e.g., SSB #m_4) and the sixth S-SSB repetition (e.g., SSB #m_5). Therefore, in the 106 RBs in the frequency band, the S-SSB repetitions and the unoccupied RBs are as follows:
1. the first S-SSB repetition, S-SSB #m_0, is transmitted from RB #0 to RB #10,
2. the second S-SSB repetition, S-SSB #m_1, is transmitted from RB #11 to RB #21,
3. the third S-SSB repetition, S-SSB #m_2, is transmitted from RB #22 to RB #32,
4. the fourth S-SSB repetition, S-SSB #m_3, is transmitted from RB #33 to RB #43,
5. the fifth S-SSB repetition. S-SSB #m_4, is transmitted from RB #44 to RB #54,
6. the unoccupied seven RBs are from RB #55 to RB #61,
7. the sixth S-SSB repetition, S-SSB #m_5, is transmitted from RB #62 to RB #72,
8. the seventh S-SSB repetition, S-SSB #m_6, is transmitted from RB #73 to RB #83,
9. the eighth S-SSB repetition, S-SSB #m_7, is transmitted from RB #84 to RB #94, and
10. the ninth S-SSB repetition, S-SSB #m_8, is transmitted from RB #95 to RB #105.

With the above S-SSB repetitions, the OCB requirement is met.

FIG. 5B illustrates another exemplary repetition structure for S-SSB in the frequency domain according to some embodiments of the present disclosure.

FIG. 5B also illustrates a frequency band with a bandwidth of 20 MHz and an SCS of 15 kHz, and the number of RBs in the frequency band equals 106, i.e., N_{RB}^{CH}=106. An S-SSB slot indexed with #m, i.e. S-SSB #m, is repeatedly mapped within the frequency band. In the example of FIG. 5B, Nᵣₑₚₑₜᵢₜᵢₒₙ^{S-SS}=2. The first S-SSB repetition, S-SSB #m_0, is to be transmitted in the first N_{RB}^{S-SSB} RBs (e.g., RB #0 to RB #10) among the RBs of the frequency band; the second S-SSB, S-SSB #m_1, is to be transmitted in the last N_{RB}^{S-SSB} RBs (e.g., RB #95 to RB #105) among the RBs of the frequency band; and the unoccupied RBs are configured to be deployed in the centre of the frequency band, e.g., from RB #11 to RB #94. With the above S-SSB repetitions, the OCB requirement is met.

Configuration information of the S-SSB repetitions may include a structure configuration in the frequency domain, which may include at least one of the following parameters:
1. a number of S-SSB repetition(s) in a frequency band, for example, the number is 9 for the exemplary FIG. 5A, while the number is 2 for the exemplary FIG. 5B;
2. location(s) of the S-SSB repetition(s) in the frequency band, for example, in FIG. 5A, the location of the first S-SSB repetition is from RB #0 to RB #10;
3. a number of RB(s) unoccupied by the S-SSB repetition(s) in the frequency band, for example, the number of unoccupied RBs is 7 for the exemplary FIG. 5A, while the number of unoccupied RBs is 84 for the exemplary FIG. 5B: or
4. location(s) of the RB(s) (i.e., unoccupied RB(s)) in the frequency band, for example, in FIG. 5A, the location of the RB(s) is from RB #55 to RB #61 in the frequency band.

The granularity and the transmission manners of the configuration information of the S-SSB repetitions are similar to those of the configuration information of the gap as described above, and the details are omitted here.

### Solution 3

In some other embodiments, the frequency band including N_{RB}^{CH} RBs in the frequency domain is divided into a number of interlaces. The number of the interlaces is denoted as T for simplicity, and every T^{th} RBs belongs to the same interlace.

An interlace may include an RB set. The maximum number of RBs in an interlace, which may be denoted as A for simplicity, may be calculated by the following equation (3):

$$A = ⌈ \frac{{N}_{RB}^{CH}}{T} ⌉ \qquad ( 3 )$$

In the case that N_{RB}^{CH} is divisible by T, the total number of RBs included in each interlace of the T interlaces is A; in the case that NRa is not divisible by T, some interlaces include A RBs while others include A−1 RBs.

If the first interlace, interlace #0, includes A RBs, it may include the 1^{st} RB, the T^{th} RB, the (2×T)^{th} RB, . . . , and the ((A−1)×T)^{th} RB. If the m^{th} interlace, interlace #m−1, includes A−1 RBs, it may include the m^{th} RB, the (m+T)^{th} RB, . . . , the (m+(A−2)×T)^{th} RB.

Among the T interlaces, there may be some interlaces that include a number of RBs which is no less than the number of RBs of an S-SSB, i.e., N_{RB}^{S-SSB}. These interlaces are considered as available interlaces, and one S-SSB may be mapped to a set (or subset) of RBs of an available interlace by one-to-one mapping. Some interlaces may include a number of RBs which is less than the number of RBs of an S-SSB, and these interlaces are considered as unavailable interlaces, in which the number of RBs is insufficient in supporting one-to-one mapping for an S-SSB. In some other embodiments, the interlaces that include a number of RBs less than the number of RBs of an S-SSB may also be considered as available interlaces for an S-SSB. For example, in the case that interlace #P includes P1 RBs, where P1 is less than N_{RB}^{S-SSB}, the next available interlace, such as interlace #(P+1), may be used jointly with the interlace #P to provide sufficient RBs in supporting one-to-one mapping for an S-SSB. In that case, the S-SSB can be mapped to the RB set of interlace #P and a part of the RB set of interlace #(P+1), and interlace #P is also considered as an available interlace. In some other embodiments, some RBs of an S-SSB may be punctured, and the S-SSB with a reduced number of RBs may be mapped to the interlace with a number of RBs less than the standard number of RBs of an S-SSB, i.e., 11 RBs.

Configuration information of the interlaces may include a structure configuration in the frequency domain, which may include at least one of the following:
1. An interlace pattern in a frequency band, which may include the number of interlaces and an RB set for each interlace;
2. The index(es) of available interlace(s) in the frequency band;
3. A number of interlace(s) to be used for one S-SSB; or
4. An indicator indicating whether FDM is enabled or disabled.

The granularity and the transmission manners of the configuration information of the interlaces are similar to those of the configuration information of the gap as described above, and the details are omitted here.

A UE may select the interlaces from the available interlaces based on the above configuration information according to any of the following solutions:

### Solution 3-1:

In this solution, FDM of multiple S-SSBs from different UEs is not supported. In other words, the indicator in the configuration information indicates that FDM is disabled. For an interlace pattern within a frequency band, the UE may first select one or more interlaces from the available interlaces for transmitting an S-SSB. In some embodiments, the UE may select the one or more interlaces based on random selection. In some other embodiments, the UE may select first one or more interlaces from the available interlaces, and the number of selected interlaces is determined to meet the reliability requirement.

After selecting the one or more available interlaces, the UE may map the S-SSB to the RB sets of the selected interlaces. The UE may start with the interlace with the minimal index and map in ascending order of RB index until up to the maximum RB index in the interlace, and then perform the same operations to other interlaces in ascending order of interlace index until up to all the selected interlaces.

### Solution 3-2:

In this solution, FDM of multiple S-SSBs from different UEs is supported. In other words, the indicator in the configuration information indicates that FDM is enabled. That is, the available interlaces of the frequency band may be used by different UEs. For an interlace pattern within a frequency band, the UE may first select one or more interlaces from the available interlaces for transmitting an S-SSB. In some embodiments, the UE may select the one or more interlaces based on random selection. In some other embodiments, the UE may select a number of interlaces from the available interlaces based on the identifier of the UE. For example, UE A may select an interlace with an index obtained by the ID of UE A modulo the number of available interlaces. UE B may select an interlace with another index obtained by the ID of UE B modulo the number of available interlaces, etc. In still some other embodiments, the UE may select a number of interlaces from the available interlaces based on an SLSS identifier associated with the UE. For example, UE A may select an interlace with an index obtained by the SLSS ID associated with UE A modulo the number of available interlaces, UE B may select an interlace with another index obtained by the SLSS ID associated with UE B modulo the number of available interlaces, etc. In still some other embodiments, the UE may select a number of interlaces from the available interlaces based on a priority level of synchronization reference of the UE. For example, according to the 3GPP specification, five priority levels of synchronization reference are defined, i.e., level 1 to level 5, and the UE may select the first interlace if its priority level of synchronization reference is level 1, select the second interlace if its priority level of synchronization reference is level 2, etc.

After selecting the one or more available interlaces, the UE may map the S-SSB to the RB sets of the selected interlaces. The UE may start with the interlace with the minimal index and map in ascending order of RB index until up to the maximum RB index in the interlace, and then perform the same operations to other interlaces in ascending order of interlace index until up to all the selected interlaces.

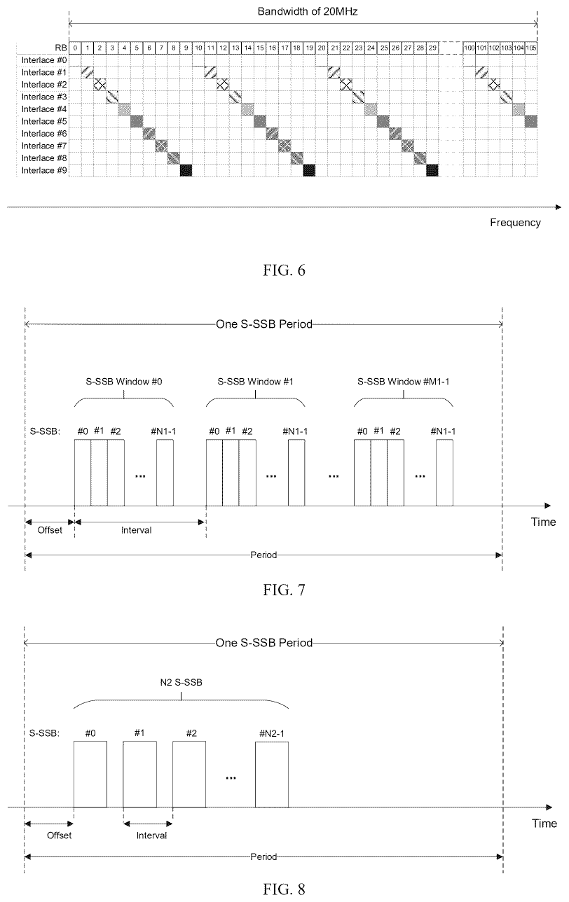

FIG. 6 illustrates an exemplary interlaced structure for S-SSB in the frequency domain according to some embodiments of the present disclosure.

FIG. 6 illustrates a frequency band with a bandwidth of 20 MHz and an SCS of 15 kHz, and the number of RBs in the frequency band equals 106, which includes RB #0, RB #1, . . . , RB #105. 10 interlaces, e.g., interlace #0, interlace #1, . . . , interlace #9, are included in the frequency band. Based on the above equation (3), the maximum number of RBs in an interlace of the 10 interlaces is calculated as follows:

$$A = ⌈ \frac{{N}_{RB}^{CH}}{T} ⌉ = ⌈ \frac{106}{10} ⌉ = 11$$

From interlace #0 to interlace #5, each interlace contains 11 RBs. For example, interlace #0 includes 11 RBs, which are RB #0, RB #10, RB #20, . . . , and RB #100; interlace #5 includes 11 RBs, which are RB #5, RB #15, RB #25, . . . , and RB #105. From interlace #6 to interlace #9, each interlace contains (A−1) RBs, i.e., 10 RBs. For example, interlace #6 includes 10 RBs, which are RB #6, RB #16, RB #26, . . . , and RB #96: interlace #9 includes 10 RBs, which are RB #9, RB #19, RB #29, . . . , and RB #99.

Each S-SSB spans N_{RB}^{S-SSB} (e.g., 11) RBs in the frequency domain. Since the number of RBs included in one S-SSB is 11, and each interlace of interlace #0 to interlace #5 includes 11 RBs, each RB of one S-SSB may be mapped to an RB of one interlace of interlace #0 to interlace #5. Therefore, interlace #0 to interlace #5 are considered as available interlaces. Each interlace of interlace #6 to interlace #9 includes 10 RBs, and they are not considered as available interlaces.

The UE may select one or more interlaces from available interlace #0 to interlace #5, and map the RBs of the S-SSB to the RB sets of the selected interlaces.

### Solution 4

In solution 4, an S-SSB period may include a number of separate S-SSB windows, and a number of S-SSB occasions may be included in an S-SSB window within the S-SSB period. The number of S-SSB occasions within one S-SSB window are deployed in a consecutive way in the time domain.

The S-SSB window is designed to support more S-SSB occasions and more opportunities for a UE to access to the channel, which is needed such as in a beam-based transmission scenario.

The S-SSB window may include the following types:
1. Type 1 window. The S-SSBs in a type 1 window are transmitted on the same beam.
2. Type 2 window. The S-SSBs in a type 2 window are transmitted on different beams, such as performing beam sweeping.
3. Type 3 window is mixed window of type 1 window and type 2 window. Some S-SSBs in a type 3 window may be transmitted on the same beam, while some other S-SSBs may be transmitted on different beams.

The number of S-SSB occasions in an S-SSB window may be determined based on at least one of the following:
1. A channel access procedure to be defined for S-SSB. For example, in the unlicensed spectrum, the channel access procedure with LBT is required before performing the S-SSB transmission.
2. A configuration of beam-based transmission, e.g., a number of transmit beams for performing the S-SSB transmission.
3. The frequency band. For example, for the higher frequency band, the S-SSB window may include more S-SSB occasions.

The BS may transmit a configuration associated with an S-SSB period including the S-SSB occasions to the UE. Specifically, the configuration may include at least one of the following:
1. A period indicates a length of the S-SSB period.
2. An offset from a starting slot of the S-SSB period to a starting slot of a first S-SSB window within the S-SSB period, which is used for performing a channel access procedure with LBT. In order to have sufficient time for performing the LBT procedure, the offset is configured to be sufficient for performing a supported LBT type prior to an S-SSB window.
3. An interval between two adjacent S-SSB windows (e.g., between starting slots of two adjacent S-SSB windows), which is used for performing a channel access procedure with LBT. The interval is determined based on LBT type. Specifically, the interval is sufficient for performing a supported LBT type prior to an S-SSB window.
4. The number of S-SSB windows within the S-SSB period, which may be represented as “M1”.
5. The number of S-SSB occasions within each S-SSB window, which may be represented as “N1′”. The S-SSB occasions are deployed in a consecutive way in each S-SSB window. That is, the N1 S-SSB occasions are consecutive in the time domain.
6. Type of S-SSB window, which may include: type 1, type 2, or type 3.
7. Information for channel access procedure, which may include the LBT type.

The granularity and the transmission manners of the configuration are similar to those of the configuration information of the gap as described above, and the details are omitted here.

FIG. 7 illustrates an exemplary distribution of S-SSB occasions within one S-SSB period according to some embodiments of the present disclosure.

In the S-SSB period, M1 S-SSB windows are included, which are S-SSB window #0, S-SSB window #1, . . . , S-SSB window #M1-1, respectively. In each S-SSB window, N1 S-SSB occasions are included, which are S-SSB occasion #0, S-SSB occasion #1, . . . , S-SSB occasion #N1−1, respectively. The period is the length of the S-SSB period. The offset is the time duration from the starting slot of the S-SSB period to the starting slot of the S-SSB window #0. The interval is the time duration from the starting slot of the S-SSB window #0 to the starting slot of the S-SSB window #1.

In some embodiments, the number of S-SSB occasions within one S-SSB window may be one, that is, N1 is one. In this case, an S-SSB window is an S-SSB occasion, and the configuration may include at least one of the following:
1. A period indicates a length of the S-SSB period.
2. An offset from a starting slot of the S-SSB period to a starting slot of a first S-SSB occasion within the S-SSB period.
3. An interval between two adjacent S-SSB occasions.
4. The number of S-SSB occasions within the S-SSB period, which may be represented as “N2”.
5. Information for a channel access procedure, which may include the LBT type.

FIG. 8 illustrates another exemplary distribution of S-SSB occasions within one S-SSB period according to some embodiments of the present disclosure.

In the S-SSB period, N2 S-SSB occasions are included, which are S-SSB occasion #0, S-SSB occasion #1, . . . , S-SSB occasion #N2-1, respectively. The period is the length of the S-SSB period. The offset is the time duration from the starting slot of the S-SSB period to the starting slot of the first S-SSB occasion, i.e., S-SSB occasion #0. The interval is the time duration from one S-SSB occasion to the next S-SSB occasion, for example, S-SSB occasion #1 to S-SSB occasion #2.

### Solution 5

Regarding the PSBCH, in R16, the PSBCH may include the following contents:
Direct Frame Number (DFN), which includes 10 bits.
Slot index, which includes 7 bits. Based on the DFN and slot index, the UE may determine the location of the S-SSB.
Coverage indicator, including 1 bit, which indicates whether the UE is in coverage or not.
TDD configuration: including 12 bits, which indicates the configuration relating to TDD.
Reserve bits: 2

In the present disclosure, it is proposed that the PSBCH includes at least one of the following information:
DFN, which may include 10 bits.
Slot index, which may include 7 bits. Since the exact transmission time of S-SSB is unknown to the receiving UE, the transmission timing needs to be included in the PSBCH.
A first indicator indicating whether an S-SSB including the PSBCH is within a COT. If the indicator indicates that the S-SSB is within a COT, it means that the S-SSB transmission is transmitted in a consecutive way. If the indicator indicates that the S-SSB is not within a COT, it means that the S-SSB transmission is a discrete transmission without a COT
A second indicator indicating whether a next S-SSB is within the current COT or not. If the indicator indicates that the next S-SSB is within the current COT, it means that the S-SSB transmission is transmitted in a consecutive way. If the indicator indicates that the S-SSB is not within the current COT, it means that the S-SSB transmission is a discrete transmission.
Parameter Q, which is utilized to support beam-based transmission of S-SSB in unlicensed spectrum by indicating the QCL relation. In some embodiments, for sidelink in an unlicensed band, the QCL assumption can be linked to PSBCH demodulation reference signal (DMRS) sequence index. S-SSBs with the same sequence index modulo the parameter Q are assumed to have the same QCL relation, that is, the S-SSBs are transmitted using the same beam.
A third indicator indicating whether a beam is used for transmission of S-SSB repeatedly within an S-SSB window or not.

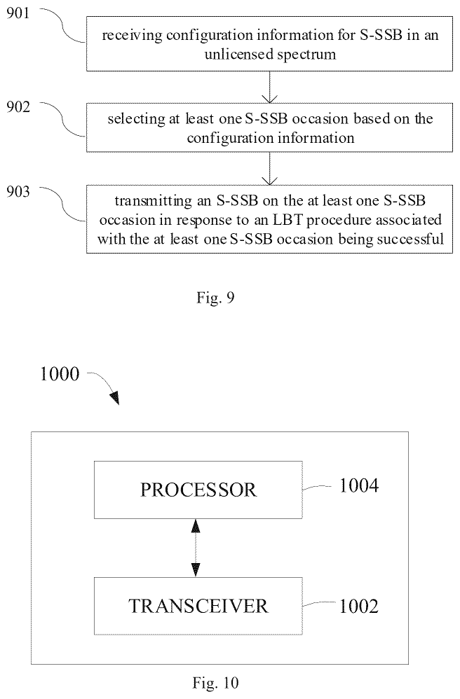

FIG. 9 illustrates a flowchart of an exemplary method for S-SSB transmission in an unlicensed spectrum according to some embodiments of the present disclosure. Although the method is described with respect to a UE below, it is contemplated that the method may be performed by any other device with similar functions.

In operation 901, the UE may receive configuration information for S-SSB in an unlicensed spectrum including at least one of the following: a first configuration associated with an S-SSB structure including at least one of: a first structure configuration in the time domain, a second structure configuration in the frequency domain, or a configuration for PSBCH: or a second configuration associated with an S-SSB period including one or more S-SSB occasions. In operation 902, the UE may select at least one S-SSB occasion based on the configuration information. In operation 903, the UE may transmit an S-SSB on the at least one S-SSB occasion in response to a LBT procedure associated with the at least one S-SSB occasion being successful.

Correspondingly, at BS side, the BS may transmit the configuration information for S-SSB in an unlicensed spectrum to the UE.

In some embodiments, the configuration information is based on at least one of the following granularities: per channel bandwidth, per carrier, per bandwidth part, per frequency range, or per SCS. In some embodiments, the configuration information is received via at least one of: a MIB message, a SIB message, a RRC signalling, or a MAC CE.

In some embodiments, the first structure configuration in the time domain includes at least one of: a number of symbol(s) as a gap for performing an LBT procedure in an S-SSB slot, or location(s) of the symbol(s) in the S-SSB slot. For example, as shown in FIG. 4, the first structure configuration in the time domain includes one symbol as a gap for performing the LBT procedure, and the location of the symbol in the S-SSB slot is at symbol #13.

In some embodiments, the second structure configuration in the frequency domain includes at least one of the following: a number of S-SSB repetition(s) in a frequency band; location(s) of the S-SSB repetition(s) in the frequency band; a number of resource block(s) (RB(s)) unoccupied by the S-SSB repetition(s) in the frequency band: or location(s) of the RB(s) in the frequency band. For example, as shown in FIG. 5A, the second structure configuration in the frequency domain includes nine S-SSB repetitions, S-SSB #m_0, S-SSB #m_1, S-SSB #m_8, the locations of the S-SSB repetitions in the frequency band; 7 RBs unoccupied by the S-SSB repetitions; or the location of the 7 RBs in the frequency band.

In some embodiments, the second structure configuration in the frequency domain includes at least one of the following: an interlace pattern in a frequency band; index(es) of available interlace(s) in the frequency band; a number of interlace(s) for one S-SSB; or an indicator indicating whether FDM is enabled. For example, as shown in FIG. 6, the second structure configuration in the frequency domain includes the interlace pattern in a frequency band, indices of available interlaces in the frequency band, which includes interlace #0 to interlace #5: the number of interlaces for one S-SSB, for example, one: or an indicator indicating whether FDM is enabled.

In some embodiments, the UE may select interlace(s) for transmitting the S-SSB from the available interlace(s) based at least in part on the second structure configuration in the frequency domain; and map the S-SSB to be transmitted to RB sets of the selected interlace(s). For example, referring to FIG. 6, the UE may select interlace #0 for transmitting the S-SSB from interlace #0 to interlace #5, and map the S-SSB to be transmitted to RB sets of interlace #0.

In some embodiments, in the case that the indicator indicating that FDM is not enabled, the UE may select the interlace(s) for transmitting the S-SSB based on random selection: or select first one or more interlaces from the available interlace(s) for transmitting the S-SSB.

In some embodiments, in the case that the indicator indicating that FDM is enabled, the UE may select the interlace(s) for transmitting the S-SSB to be transmitted based on at least one of: random selection, an identifier of the UE, an identifier of a sidelink synchronization signal (SLSS) associated with the UE, or a priority level of synchronization reference of the UE.

In some embodiments, the configuration for PSBCH indicates that a PSBCH includes at least one of the following: a first indicator indicating whether an S-SSB including the PSBCH is within a COT; a second indicator indicating whether a next S-SSB is within a current COT; a parameter associated with QCL relation; or a third indicator indicating whether a beam is used for transmission of S-SSB repeatedly within an S-SSB window or not.

In some embodiments, the second configuration includes at least one of the following: a period indicating a length of the S-SSB period: a number of S-SSB window(s) within the S-SSB period: a number of S-SSB occasion(s) within each S-SSB window; an offset from a starting slot of the S-SSB period to a starting slot of a first S-SSB window of the S-SSB window(s) within the S-SSB period; an interval between starting slots of two adjacent S-SSB windows; an indicator indicating whether each S-SSB window is a type 1 window, a type 2 window, or a type 3 window; or an LBT procedure type. For example, referring to FIG. 7, the second configuration includes a period indicating a length of the S-SSB period, which is marked by “Period”; a number of S-SSB windows within the S-SSB period, which is M1; a number of S-SSB occasions within each S-SSB window, which is N1: an offset from a starting slot of the S-SSB period to a starting slot of a first S-SSB window of the S-SSB windows within the S-SSB period, which is marked by “Offset” in FIG. 7; an interval between starting slots of two adjacent S-SSB windows, which is marked by “Interval” in FIG. 7, an indicator indicating whether each S-SSB window is a type 1 window, a type 2 window, or a type 3 window; or an LBT procedure type.

In some embodiments, the number of the S-SSB occasion(s) within each S-SSB window is determined based on at least one of the following: a channel access procedure associated with an S-SSB: a configuration of beam-based sidelink transmission; or a frequency band associated with the S-SSB. For instance, according to table 1, the higher frequency band may be configured with more S-SSB occasions with each S-SSB window.

FIG. 10 illustrates a simplified block diagram of an exemplary apparatus for S-SSB transmission in an unlicensed spectrum according to some embodiments of the present disclosure.

As shown in FIG. 10, the apparatus 1000 may include at least one processor 1004 and at least one transceiver 1002 coupled to the processor 1004. The apparatus 1000 may be a UE or a BS or any other device with similar functions.

Although in this figure, elements such as the at least one transceiver 1002 and processor 1004 are described in the singular, the plural is contemplated unless a limitation to the singular is explicitly stated. In some embodiments of the present disclosure, the transceiver 1002 may be divided into two devices, such as a receiving circuitry and a transmitting circuitry. In some embodiments of the present disclosure, the apparatus 1000 may further include an input device, a memory, and/or other components.

In some embodiments of the present disclosure, the apparatus 1000 may be a UE. The transceiver 1002 and the processor 1004 may interact with each other so as to perform the operations of the UE described in any of FIGS. 1-9. In some embodiments of the present disclosure, the apparatus 1000 may be a BS. The transceiver 1002 and the processor 1004 may interact with each other so as to perform the operations of the BS described in any of FIGS. 1-9.

In some embodiments of the present disclosure, the apparatus 1000 may further include at least one non-transitory computer-readable medium.

For example, in some embodiments of the present disclosure, the non-transitory computer-readable medium may have stored thereon computer-executable instructions to cause the processor 1004 to implement the method with respect to the UE as described above. For example, the computer-executable instructions, when executed, cause the processor 1004 interacting with transceiver 1002 to perform the operations of the UE described in any of FIGS. 1-9.

In some embodiments of the present disclosure, the non-transitory computer-readable medium may have stored thereon computer-executable instructions to cause the processor 1004 to implement the method with respect to the BS as described above. For example, the computer-executable instructions, when executed, cause the processor 1004 interacting with transceiver 1002 to perform the operations of the BS described in any of FIGS. 1-9.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive configuration information for sidelink synchronization signal block (S-SSB) in an unlicensed spectrum including at least one of:
a first configuration associated with an S-SSB structure including at least one of: a first structure configuration in a time domain, a second structure configuration in a frequency domain, or a configuration for physical sidelink broadcast channel (PSBCH); or
a second configuration associated with an S-SSB period including one or more S-SSB occasions;
select at least one S-SSB occasion based on the configuration information; and
transmit an S-SSB on the at least one S-SSB occasion in response to a listen before talk (LBT) procedure associated with the at least one S-SSB occasion being successful.

2. The UE of claim 1, wherein the configuration information is based on a granularity of at least one of:
per channel bandwidth,
per carrier,
per bandwidth part,
per frequency range, or
per subcarrier spacing (SCS).

3. The UE of claim 1, wherein the configuration information is received via at least one of: a master information block (MIB) message, a system information block (SIB) message, a radio resource control (RRC) signaling, or a medium access control (MAC) control element (CE).

4. The UE of claim 1, wherein the first structure configuration in the time domain includes at least one of: a number of symbol(s) as a gap for performing an LBT procedure in an S-SSB slot, or location(s) of the symbol(s) in the S-SSB slot.

5. The UE of claim 1, wherein the second structure configuration in the frequency domain includes at least one of:
a number of S-SSB repetition(s) in a frequency band;
location(s) of the S-SSB repetition(s) in the frequency band;
a number of resource block(s)(RB(s))unoccupied by the S-SSB repetition(s) in the frequency band; or
location(s) of the RB(s) in the frequency band.

6. The UE of claim 1, wherein the second structure configuration in the frequency domain includes at least one of:
an interlace pattern in a frequency band;
index(es) of available interlace(s) in the frequency band;
a number of interlace(s) for one S-SSB; or
an indicator indicating whether frequency domain multiplexing (FDM) is enabled.

7. The UE of claim 6, wherein the at least one processor is further configured to cause the UE to:
select interlace(s) for transmitting the S-SSB from the available interlace(s) based at least in part on the second structure configuration in the frequency domain; and
map the S-SSB to be transmitted to resource block (RB) sets of the selected interlace(s).

8. The UE of claim 7, wherein in a case that the indicator indicates that FDM is not enabled, the at least one processor is further configured to cause the UE to:
select the interlace(s) for transmitting the S-SSB based on random selection; or
select first one or more interlaces from the available interlace(s) for transmitting the S-SSB.

9. The UE of claim 7, wherein in a case that the indicator indicates that FDM is enabled, the at least one processor is further configured to cause the UE to:
select the interlace(s) for transmitting the S-SSB based on at least one of: random selection, an identifier of the UE, an identifier of a sidelink synchronization signal (SLSS) associated with the UE, or a priority level of synchronization reference of the UE.

10. The UE of claim 1, wherein the configuration for PSBCH indicates that a PSBCH includes at least one of:
a first indicator indicating whether an S-SSB including the PSBCH is within a channel occupancy time (COT);
a second indicator indicating whether a next S-SSB is within a current COT;
a parameter associated with quasi-colocation (QCL) relation; or
a third indicator indicating whether a beam is used for transmission of S-SSB repeatedly within an S-SSB window or not.

11. The UE of claim 1, wherein the second configuration includes at least one of:
a length of the S-SSB period;
a number of S-SSB window(s) within the S-SSB period;
a number of S-SSB occasion(s) within each S-SSB window;
an offset from a starting slot of the S-SSB period to a starting slot of a first S-SSB window of the S-SSB window(s) within the S-SSB period;
an interval between starting slots of two adjacent S-SSB windows;
an indicator indicating whether each S-SSB window is a type 1 window, a type 2 window, or a type 3 window; or
an LBT procedure type.

12. The UE of claim 11, wherein each S-SSB window includes only one S-SSB occasion.

13. The UE of claim 11, wherein the number of the S-SSB occasion(s) within each S-SSB window is determined based on at least one of:
a channel access procedure associated with an S-SSB;
a configuration of beam-based sidelink transmission; or
a frequency band associated with the S-SSB.

14. A base station (BS) for wireless communication, comprising:
at least one memory, and
at least one processor coupled with the at least one memory and configured to cause the BS to:
transmit configuration information for sidelink synchronization signal block (S-SSB) in an unlicensed spectrum including at least one of:
a first configuration associated with an S-SSB structure including at least one of: a first structure configuration in a time domain, a second structure configuration in a frequency domain, or a configuration for physical sidelink broadcast channel (PSBCH); or
a second configuration associated with an S-SSB period including one or more S-SSB occasions.

15. A method performed by a user equipment (UE), the method comprising:
receiving configuration information for sidelink synchronization signal block (S-SSB) in an unlicensed spectrum including at least one of:
a first configuration associated with an S-SSB structure including at least one of: a first structure configuration in a time domain, a second structure configuration in a frequency domain, or a configuration for physical sidelink broadcast channel (PSBCH); or
a second configuration associated with an S-SSB period including one or more S-SSB occasions;
selecting at least one S-SSB occasion based on the configuration information; and
transmitting an S-SSB on the at least one S-SSB occasion in response to a listen before talk (LBT) procedure associated with the at least one S-SSB occasion being successful.

16. A processor for wireless communication, comprising:
at least one controller coupled with at least one memory and configured to cause the processor to:
receive configuration information for sidelink synchronization signal block (S-SSB) in an unlicensed spectrum including at least one of:
a first configuration associated with an S-SSB structure including at least one of: a first structure configuration in a time domain, a second structure configuration in a frequency domain, or a configuration for physical sidelink broadcast channel (PSBCH); or
a second configuration associated with an S-SSB period including one or more S-SSB occasions;
select at least one S-SSB occasion based on the configuration information; and
transmit an S-SSB on the at least one S-SSB occasion in response to a listen before talk (LBT) procedure associated with the at least one S-SSB occasion being successful.

17. The processor of claim 16, wherein the configuration information is based on a granularity of at least one of:
per channel bandwidth,
per carrier,
per bandwidth part,
per frequency range, or
per subcarrier spacing (SCS).

18. The processor of claim 16, wherein the configuration information is received via at least one of: a master information block (MIB) message, a system information block (SIB) message, a radio resource control (RRC) signaling, or a medium access control (MAC) control element (CE).

19. The processor of claim 16, wherein the second structure configuration in the frequency domain includes at least one of:
a number of S-SSB repetition(s) in a frequency band;
location(s) of the S-SSB repetition(s) in the frequency band;
a number of resource block(s)(RB(s))unoccupied by the S-SSB repetition(s) in the frequency band; or
location(s) of the RB(s) in the frequency band.

20. The processor of claim 16, wherein the second configuration includes at least one of:
a length of the S-SSB period;
a number of S-SSB window(s) within the S-SSB period,
a number of S-SSB occasion(s) within each S-SSB window;
an offset from a starting slot of the S-SSB period to a starting slot of a first S-SSB window of the S-SSB window(s) within the S-SSB period;
an interval between starting slots of two adjacent S-SSB windows;
an indicator indicating whether each S-SSB window is a type 1 window, a type 2 window, or a type 3 window; or
an LBT procedure type.
